(19) United States
(12) Patent Application Publication
(10) Pub. No.: US 2026/0356763 A1
(43) Pub. Date: Nov. 12, 2026

(54) REFRACTORY MATERIALS FOR ULTRA-HIGH TEMPERATURE AND MANUFACTURING METHOD THEREOF

(71) Applicant: Pusan National University Industry-University Cooperation Foundation, Busan (KR)

(72) Inventors: Jong Mok Ok, Busan (KR); Young Hyun Lee, Busan (KR)

(21) Appl. No.: 19/664,708

(22) Filed: Apr. 30, 2026

(30) Foreign Application Priority Data
May 8, 2025 (KR) 10-2025-0059501

(51) Int. Cl. C04B 35/48

(52) U.S. Cl. CPC C04B 35/48; C04B 2235/3246; C04B 2235/604; C04B 2235/612; C04B 2235/6567; C04B 2235/661; C04B 2235/77

(57) ABSTRACT

An ultra‑high‑temperature refractory material includes a first layer that includes a zirconia support made of yttria‑stabilized zirconia (YSZ) to maintain temperature in a high‑temperature (1800 °C) kiln for synthesizing functional new materials, especially ceramic‑type materials, and a second layer made of castable zirconia.

### CROSS-REFERENCE TO RELATED APPLICATION

The present application claims priority under 35 U.S.C. §119(a) to Korean Patent Application No. 10-2025-0059501 filed in the Korean Intellectual Property Office on May 8, 2025, which is incorporated herein by reference in its entirety.

### TECHNICAL FIELD

The present disclosure relates to refractory material for ultra‑high temperature use and its manufacturing method.

### BACKGROUND ART

Generally, refractory material used in kilns must be able to withstand temperatures of around 1500°C. Recently, to synthesize functional new materials, especially ceramic-type materials (e.g., Ga₂O₃ for the production of power‑semiconductor single crystals), kilns capable of even higher temperatures (1800°C) are required compared to before.

Refractory materials are essential for ensuring the stability and durability of internal furnace structures under high‑temperature conditions. However, existing refractories lack resistance to thermal shock or have short service lives, necessitating improvement. In particular, there is no refractory that provides the required insulation while minimizing deformation to maintain a temperature of 1800 °C in an atmospheric environment, creating a demand for the development of ultra‑high‑temperature refractories that minimize both heat loss and deformation.

### SUMMARY OF THE INVENTION

### Problem to be solved

The object of present disclosure is to provide an ultra‑high temperature refractory material that minimizes heat loss and deformation.

The technical problems that the present disclosure seeks to address are not limited to those mentioned above; other, unmentioned technical problems can be clearly understood by a person of ordinary skill in the art to which the present disclosure belongs, based on the following disclosure.

### Means for Solving the Problem

To achieve the foregoing object, the present disclosure provides an ultra‑high‑temperature refractory comprising a first layer that includes a zirconia support made of compression‑molded yttria‑stabilized zirconia (Yttria Stabilized Zirconia, YSZ) and a second layer comprising castable refractory; wherein the zirconia support of the first layer has top and bottom surfaces forming an identical polygonal structure, includes a framework that prevents twisting and one or more passages extending through the top and bottom surfaces, and the interior of the zirconia support of the first layer is filled with the castable refractory.

The yttria-stabilized zirconia comprises zirconia mixed with yttria, wherein the molar ratio of zirconia to yttria may be from 95:5 to 90:10.

The castable refractory material is characterized by being manufactured by shaping and sintering zirconia mixed with calcium.

The Ca-mixed zirconia may contain Ca in an amount of 5 to 15 mol% based on 100 mol% of the Ca-mixed zirconia.

Furthermore, the present disclosure provides a method for manufacturing ultra‑high‑temperature refractory comprising: a first step of compressing yttria‑stabilized zirconia (YSZ) powder; a second step of producing a zirconia support with a polygonal structure containing one or more passages by machining the compressed yttria‑stabilized zirconia; a third step of sintering the produced zirconia support in a primary sintering and a secondary sintering; a fourth step of using the primary‑ and secondary‑sintered zirconia support as a molding die, filling a sponge into the interior of the die, and then filling the sponge‑filled zirconia support with castable zirconia in slurry form; and a fifth step of sintering the zirconia support filled with castable zirconia to produce a porous‑structured castable refractory.

The yttria-stabilized zirconia comprises zirconia mixed with yttria, wherein the molar ratio of zirconia to yttria may be from 95:5 to 90:10.

In the first step, the yttria-stabilized zirconia powder can be compressed to 20 to 100 MPa.

In the third step, the first sintering is performed at 1,000 to 3,000°C for 1 to 5 hours, and the second sintering can be performed at 2,000 to 3,000°C for 10 to 100 seconds.

The density of the sponge may be 0.05 to 0.3 g/cm³.

The castable zirconia comprises zirconia mixed with Ca, wherein the Ca‑mixed zirconia may contain Ca in an amount of 5 to 15 mol% based on 100 mol% of the Ca‑mixed zirconia.

In step 5, the zirconia support filled with the castable zirconia may be cured at 100 to 300°C for 1 to 5 hours, followed by sintering at 700 to 1100°C for 1 to 5 hours.

### Effect of the Invention

According to the means for solving the above problem, the present disclosure can provide an ultra‑high‑temperature refractory material that exhibits minimal deformation at high temperatures and excellent insulating performance, as well as a method for producing the same.

The advantages of the present disclosure are not limited to the effects mentioned above, and other unmentioned benefits will be readily understood by those skilled in the art from the disclosures of the claims.

### BRIEF DESCRIPTION OF THE DRAWINGS

FIG. 1 depicts a compressed molded zirconia support according to an example of the present disclosure.

FIG. 2 shows a castable refractory material according to an example of the present disclosure.

FIG. 3 shows photographs of sponges according to density (from the top: 0.02 g/cm³, 0.1 g/cm³, 0.5 g/cm³, 0.8 g/cm³).

FIG. 4 depicts a photograph of a castable refractory material that, after high‑temperature sintering, retains only the sponge shape.

FIG. 5 shows the front side of the refractory material produced in the example and comparative example.

FIG. 6 shows the thermal conductivity test results of the refractory material produced in the examples and comparative examples.

FIG. 7 schematically shows the refractory material according to an example of the present disclosure attached to an ultra‑high‑temperature rectangular furnace for measuring the insulation effect.

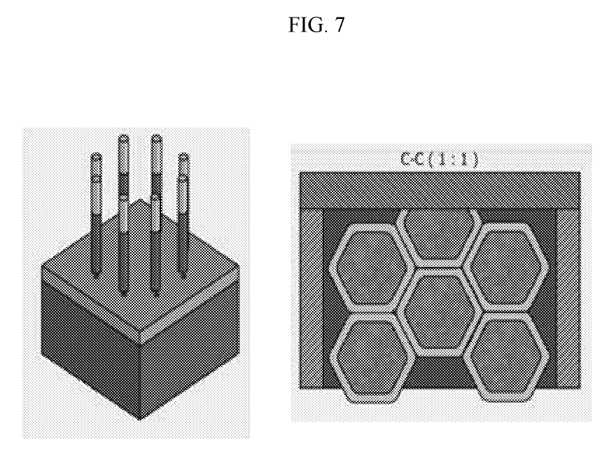

FIG. 8 shows the results of measuring the temperature‑retention effect at a 1800 °C environment after attaching the refractory material, according to an example of the present disclosure, to an ultra‑high‑temperature rectangular furnace.

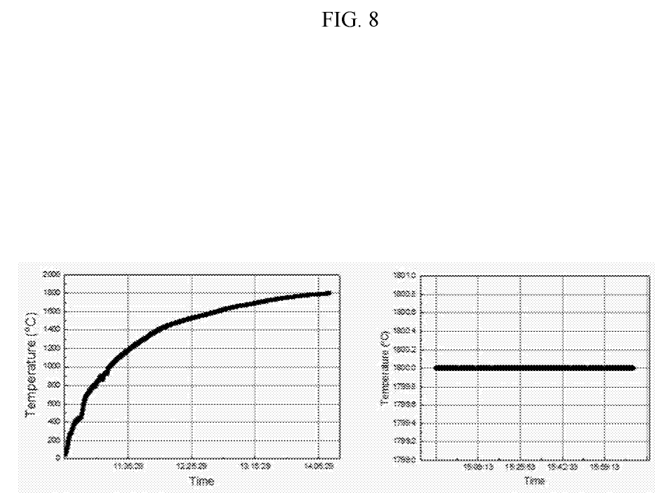

### DETAILED DESCRIPTION FOR IMPLEMENTING THE DISCLOSURE

The terms used in the present disclosure have been selected from generally accepted, widely used terminology insofar as possible while considering the functions of the disclosure; however, they may vary depending on the intent of practitioners in the field, case law, the emergence of new technologies, and so forth. In certain instances, the applicant may arbitrarily choose terms, and in such cases the specific meaning will be detailed in the description of the corresponding disclosure. Accordingly, the terms employed in the present disclosure should not be regarded merely as nominal labels but must be defined based on the meaning of the terms and the overall content of the disclosure.

Unless otherwise defined, all terms used herein, including technical or scientific terms, have the same meaning as would be commonly understood by a person of ordinary skill in the art to which the present disclosure belongs. Terms that are defined in commonly used dictionaries or that are generally used should be interpreted as having a meaning consistent with the context of the relevant technology, and, unless expressly defined in this application, they shall not be interpreted in an idealistic or overly formal sense.

When any part of the specification is said to “include” a particular component, this means that, unless there is an explicit contrary statement, it does not exclude other components but may also include additional components.

Below, with reference to the attached drawings, the examples of the present disclosure are described in detail so that a person having ordinary skill in the art to which the disclosure pertains can readily practice them. However, the present disclosure can be implemented in various different forms and is not limited to the examples described herein.

Hereinafter, the present disclosure will be described in detail.

The present disclosure provides an ultra‑high‑temperature refractory comprising a first layer that includes a zirconia support made of compressed yttria‑stabilized zirconia (YSZ) and a second layer made of castable refractory; the zirconia support of the first layer has top and bottom surfaces forming an identical polygonal structure, includes a framework that prevents twisting and one or more passages extending through the top and bottom surfaces, and the interior of the zirconia support of the first layer is filled with the castable refractory.

The yttria-stabilized zirconia comprises zirconia mixed with yttria, wherein the molar ratio of zirconia to yttria may be from 95:5 to 90:10. Preferably, the molar ratio of zirconia to yttria may be from 93:7 to 91:9, although it is not limited to this.

The aforementioned yttria-stabilized zirconia is a material resistant to thermal shock, serves as a support for the refractory material, and functions as a supporting structure that prevents warping or cracking due to thermal shock after molding.

The compressed molded yttria‑stabilized zirconia can be manufactured in a form having one or more passages of a polygonal structure by compressing the yttria‑stabilized zirconia at 20 to 100 MPa and then machining it.

The castable refractory is characterized by being manufactured by shaping and sintering calcium‑mixed zirconia. More specifically, the interior of the first‑layer yttria‑stabilized zirconia support is filled with a sponge, and a slurry of calcium‑mixed zirconia is introduced into the sponge‑filled zirconia support; after hardening and sintering, a porous‑structured castable refractory is produced.

The Ca‑mixed zirconia may contain Ca in an amount of 5 to 15 mol% based on 100 mol% of the Ca‑mixed zirconia. Preferably, the Ca content may be 5 to 10 mol% based on 100 mol% of the Ca‑mixed zirconia, and more preferably, it may be 7 to 9 mol% based on 100 mol% of the Ca‑mixed zirconia, although it is not limited to these ranges.

The aforementioned castable refractory material is weak against thermal shock, but it has excellent ultra‑high temperature insulation performance.

Furthermore, the present disclosure provides a method for manufacturing ultra‑high‑temperature refractory comprising: a first step of compressing yttria‑stabilized zirconia (YSZ) powder; a second step of producing a zirconia support with a polygonal structure containing one or more passages by machining the compressed yttria‑stabilized zirconia; a third step of sintering the produced zirconia support in a primary sintering and a secondary sintering; a fourth step of using the primary‑ and secondary‑sintered zirconia support as a molding die, filling a sponge into the interior of the die, and then filling the sponge‑filled zirconia support with castable zirconia in slurry form; and a fifth step of sintering the zirconia support filled with castable zirconia to produce a porous‑structured castable refractory.

First, a first step of compressing yttria-stabilized zirconia (YSZ) powder may be performed.

Zirconia (ZrO₂) is a representative ceramic material that exhibits a crystal structure that changes with temperature. Such structural changes are called phase transformations and play a very important role in zirconia’s mechanical properties and applications.

Zirconia has the following crystal structures depending on temperature.

Monoclinic: a structure stable at room temperature

Tetragonal system: transitions to a stable structure at approximately 1170 °C or higher.

Cubic: a high‑temperature stable structure formed at approximately 2370 °C or higher.

That is, as the temperature rises, zirconia undergoes phase transitions in the order of monoclinic → tetragonal → cubic.

During cooling, the transition occurs in the opposite direction, and this process results in a volume change of about 3–5%. This generates internal stresses in the material, which can lead to cracks or failure. Because insulation materials must not undergo deformation or crack failure while experiencing high and low temperatures, yttria is added to produce a stabilized zirconia (Y‑TZP) form. Y‑TZP is zirconia whose tetragonal phase is stabilized at room temperature by the addition of Y₂O₃ (yttria). When a crack forms, local stress induces a tetragonal‑to‑monoclinic phase transition, and the resulting volume expansion suppresses crack propagation; this is called transformation toughening.

The yttria-stabilized zirconia comprises zirconia mixed with yttria, wherein the molar ratio of zirconia to yttria may be from 95:5 to 90:10. Preferably, the molar ratio of zirconia to yttria may be from 93:7 to 91:9, although it is not limited to this.

In step 1, the yttria‑stabilized zirconia powder may be compressed to a pressure of 20 to 100 MPa. Preferably, it may be compressed to 30 to 70 MPa, and more preferably to 40 to 60 MPa, although it is not limited to these values.

The compressed yttria‑stabilized zirconia can serve as a support structure with high density yet low deformation at elevated temperatures.

Next, a second step can be performed to manufacture a yttria‑stabilized zirconia support having a polygonal structure with one or more passages by machining the compressed yttria‑stabilized zirconia.

For a zirconia disc that is completely filled, even if the zirconia is highly stabilized, a slight change in the crystal structure cannot overcome the dense inter‑particle packing, leading to microcracks and gaps. However, by manufacturing the disc through the aforementioned machining process into a structure that disperses the forces associated with micro‑expansion, a stabilized zirconia support can be produced that remains hard and exhibits a low expansion rate of less than 1 % even when the crystal structure changes at high temperature.

Next, a third step of performing a first sintering and a second sintering on the manufactured zirconia support can be carried out.

In step 3, the primary sintering may be performed at a temperature of 1,000 to 3,000 °C for a duration of 1 to 5 hours. Preferably, the primary sintering may be carried out at 1,000 to 2,000 °C for 1 to 4 hours, and more preferably at 1,300 to 1,700 °C for 1 to 3 hours, although it is not limited to these ranges. The secondary sintering may be performed at a temperature of 2,000 to 3,000 °C for 10 to 100 seconds. Preferably, it may be carried out at 2,000 to 2,500 °C for 10 to 70 seconds, and more preferably at 2,200 to 2,400 °C for 20 to 50 seconds, although it is not limited to these ranges.

The second sintering may be carried out in an insulated small space using multiple oxygen-fuel torches.

The first sintering can increase the compressive strength to about 1,000 MPa or more, thereby enhancing the strength, and the second sintering, performed at a high temperature, can subject the zirconia support to high‑temperature thermal shock, allowing it to possess a cubic crystal structure.

Next, the fourth step can be performed, in which the zirconia support that has completed primary and secondary sintering is used as a molding die, a sponge is placed inside the mold, and a slurry-form castable zirconia is filled into the zirconia support containing the sponge.

The density of the sponge may be 0.05 to 0.3 g/cm³. Preferably, the density of the sponge may be 0.05 to 0.2 g/cm³, and more preferably 0.05 to 0.15 g/cm³, although it is not limited to these ranges. Because thermal conductivity varies with porosity, a higher porosity for a given volume indicates superior insulating performance. However, if the sponge density falls below the aforementioned range, more pores are formed but the structural strength becomes weak and the sponge may collapse.

The castable zirconia comprises zirconia mixed with Ca, wherein the Ca‑containing zirconia may contain Ca in an amount of 5 to 15 mol % based on 100 mol % of the Ca‑containing zirconia. Preferably, the Ca‑containing zirconia may contain Ca in an amount of 5 to 10 mol % based on 100 mol % of the Ca‑containing zirconia, and more preferably, the Ca‑containing zirconia may contain Ca in an amount of 7 to 9 mol % based on 100 mol % of the Ca‑containing zirconia, although this is not limiting.

Next, the fifth step of manufacturing a porous-structured castable refractory can be performed by sintering a zirconia support filled with the aforementioned castable zirconia.

During the sintering process, the sponge spontaneously ignites and disappears, thereby forming a castable refractory material with a porous structure.

Before sintering, a step of curing the zirconia support filled with the castable zirconia at room temperature for 20 to 30 hours may be further included.

In step 5, the zirconia support filled with castable zirconia may be cured at 100°C to 300°C for 1 to 5 hours, followed by sintering at 700°C to 1100°C for 1 to 5 hours. Preferably, it may be cured at 150°C to 250°C for 1 to 3 hours, followed by sintering at 800°C to 1000°C for 1 to 3 hours, although this is not limiting.

The castable refractory material has a lower density than the zirconia support (density 6.0 g/cm³) made of yttria‑stabilized zirconia. Because it is not compression‑molded, its intermolecular bonding is low, resulting in weak strength; however, as an insulating material, the larger inter‑particle spacing and the presence of pores give it superior thermal‑insulation performance, with a thermal conductivity of about 0.5–1.5 W/m·K (room‑temperature, depending on porosity) compared to 2–3 W/m·K for conventional compressed zirconia (room‑temperature).

Hereinafter, the disclosure will be described in detail by way of example in order to explain the disclosure concretely. However, the examples of the present disclosure may be varied in many other forms, and the scope of the disclosure shall not be interpreted as being limited to the examples described below. The examples in this specification are provided to more fully explain the disclosure to a person having ordinary skill in the art.

### Example

### 1. Manufacturing a zirconia support

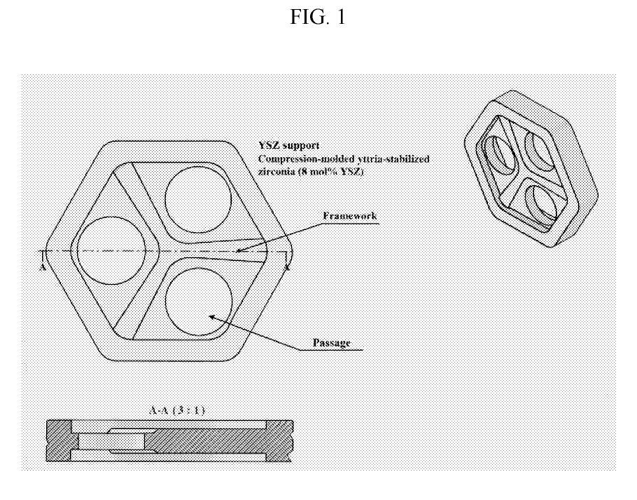

After compressively molding zirconia powder containing 8 mol% yttria at approximately 50 MPa at room temperature, it was machined into a polygonal structure with three holes. Then it was sintered for 2 hours at 1400–1550 °C, achieving a compressive strength of about 1000 MPa or higher to reinforce its strength. Finally, a high‑temperature thermal shock was applied by sintering within 30 seconds at an extremely high temperature of about 2,300 °C using multiple oxygen-fuel torches in a small insulated space, forming a cubic crystal system. The fabricated zirconia support is shown in FIG. 1.

### 2. Manufacturing of castable refractory

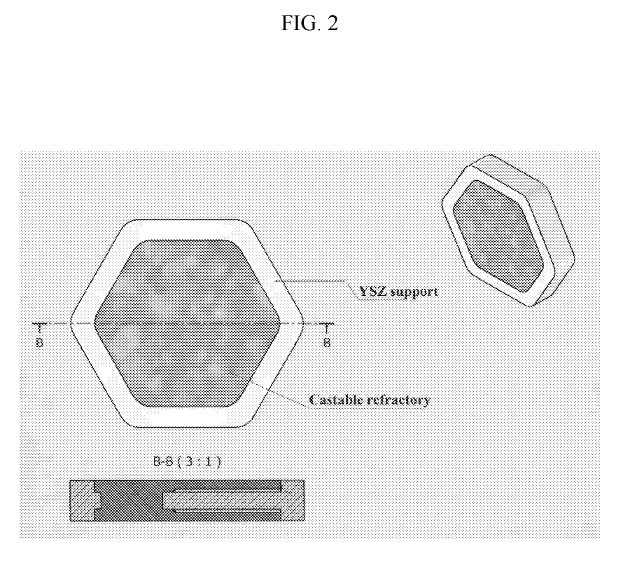

The sponge (density approximately 0.1 g/cm³) was placed inside the molded zirconia support, a slurry‑type castable zirconia was added, and the assembly was cured at room temperature for 24 hours, then at 200 °C for 2 hours, and finally at 900 °C for 2 hours. During the high‑temperature sintering, the sponge spontaneously ignited and vanished, forming a castable refractory with a porous structure. The resulting castable refractory is shown in FIG. 2.

### Comparative Example

After cold pressing a zirconia powder containing 8 mol% yttria at approximately 50 MPa at room temperature, it was sintered for 2 hours at 1400–1550 °C, resulting in a compressive strength of about 1000 MPa or more to enhance the strength. Subsequently, a high‑temperature thermal shock was applied by sintering in less than 30 seconds at a temperature of about 2,300 °C using multiple oxygen-fuel torches in a small insulated space, thereby forming a cubic crystal structure.

### Example 1 : Comparison of sponges according to density

We manufactured refractory material using sponges of various densities (0.02 g/cm³, 0.1 g/cm³, 0.5 g/cm³, and 0.8 g/cm³) and compared their shapes after high‑temperature sintering.

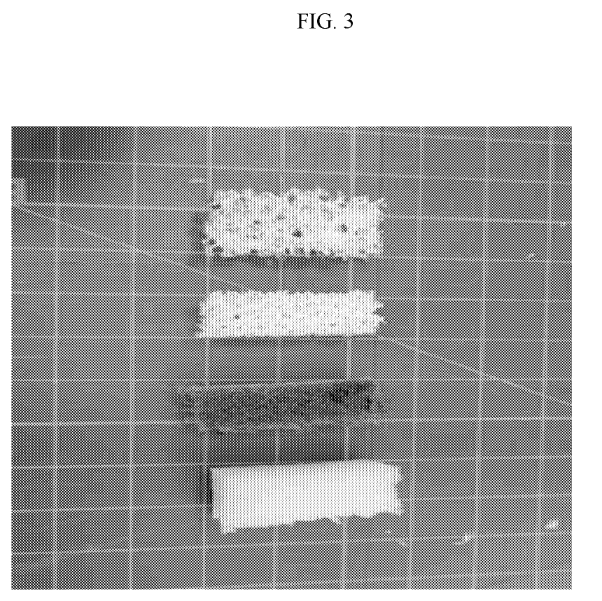

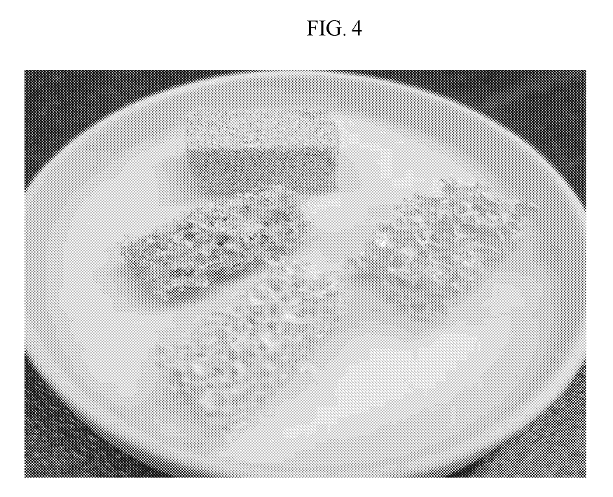

FIG. 3 shows photographs of sponges according to density. It can be seen that porosity varies with density. When comparing castable refractory material that retains only the shape of the sponge after high‑temperature sintering, it was observed that when the sponge density falls below 0.1 g/cm³, more pores are formed, but the structural strength is weakened, causing it to collapse (FIG. 4).

### Example 2 : Thermal Conductivity Experiment

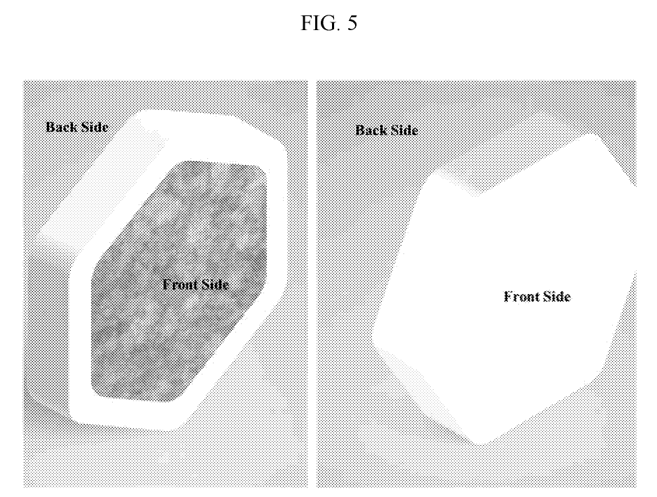

Refractory specimens produced in the examples and comparative examples were each positioned, and a flame from an oxygen torch was applied from a distance of 10 cm from the front side (FIG. 5); the central temperature of the rear side was measured with an infrared temperature sensor. The thickness of the refractory sample was measured as 10 mm.

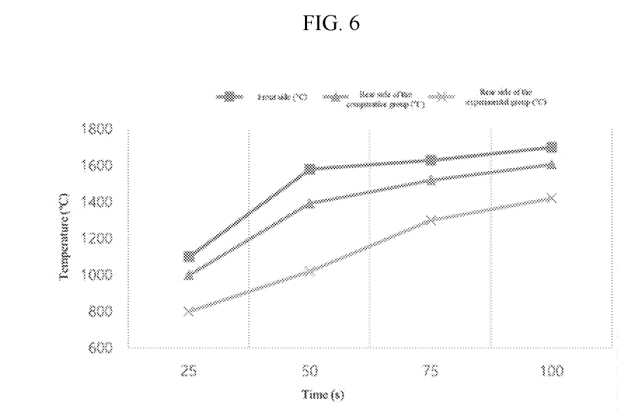

Referring to FIG. 6, the example showed a rear temperature that was on average about 283°C lower. The typical thermal conductivity of zirconia at room temperature is about 2 W/m·K, and at the maximum temperature of 1,700°C the example’s thermal conductivity was measured at 7.44 W/m·K, whereas the control’s thermal conductivity was 22.64 W/m·K, indicating roughly a threefold lower conductivity at high temperature. This suggests that the insulation performance at ultra‑high temperatures can be more than three times better.

### Example 3: Measurement of Temperature Maintenance Effect

The refractory material produced in the above example was attached to the inner wall of the ultra‑high‑temperature rectangular furnace, and it was verified whether the temperature could be maintained in an actual 1800°C environment. In the experiment, the innermost corners of all side walls inside the box were finished with this insulation material, while the top and bottom were treated with ordinary insulation.

For a typical furnace, it is operated at a rate of 300°C per hour (average 5°C/min), but to simulate a thermal‑shock scenario it reached 1,800°C in about three hours, achieving a temperature rise at an average rate of 10°C/min—twice as fast. After reaching 1,800°C, it was confirmed that the temperature could be maintained at 1,800°C for approximately one hour with an error margin of ±0.1 °C.

We have examined the specific examples of the present disclosure to date. A person of ordinary skill in the art to which the present disclosure belongs would understand that the disclosure can be realized in modified forms, provided they do not depart from its essential characteristics. Accordingly, the disclosed examples should be considered from a descriptive, not a limiting, perspective. The scope of the present disclosure is defined not by the foregoing description but by the claims, and any differences falling within an equivalent scope should be interpreted as being included in the disclosure.

What is claimed is:

1. An ultra-high-temperature refractory, comprising:
a first layer comprising a zirconia support made of compression-molded yttria-stabilized zirconia (YSZ); and a second layer comprising a castable refractory, wherein the zirconia support of the first layer has an upper surface and a lower surface having a same polygonal shape, includes a framework configured to prevent twisting, and one or more passages extending through the upper surface and the lower surface, and wherein an interior of the zirconia support of the first layer is filled with the castable refractory.

2. The ultra-high-temperature refractory of claim 1, wherein the yttria-stabilized zirconia comprises zirconia mixed with yttria, and a molar ratio of the zirconia to the yttria is from 95:5 to 90:10.

3. The ultra-high-temperature refractory of claim 1, wherein the castable refractory is produced by shaping and sintering calcium-mixed zirconia.

4. The ultra-high-temperature refractory of claim 3, wherein the calcium-mixed zirconia contains calcium in an amount of 5 to 15 mol% based on 100 mol% of the calcium-mixed zirconia.

5. A method for manufacturing an ultra-high-temperature refractory, the method comprising:
compressing yttria-stabilized zirconia (YSZ) powder;
machining the compressed yttria-stabilized zirconia to produce a zirconia support having a polygonal structure with one or more passages;
subjecting the zirconia support to primary sintering and secondary sintering;
using the zirconia support after completion of the primary sintering and the secondary sintering as a molding die, placing a sponge in an interior of the molding die, and filling the zirconia support containing the sponge with slurry-form castable zirconia; and
sintering the zirconia support filled with the castable zirconia to produce a castable refractory having a porous structure.

6. The method of claim 5, wherein the yttria-stabilized zirconia comprises zirconia mixed with yttria, and a molar ratio of the zirconia to the yttria is from 95:5 to 90:10.

7. The method of claim 5, wherein the compressing comprises compressing zirconia powder mixed with yttria at 20 to 100 MPa.

8. The method of claim 5, wherein, in the subjecting of the zirconia support to the primary sintering and the secondary sintering, the primary sintering is performed at 1,000 to 3,000°C for 1 to 5 hours, and the secondary sintering is performed at 2,000 to 3,000°C for 10 to 100 seconds.

9. The method of claim 5, wherein the sponge has a density of 0.05 to 0.3 g/cm³.

10. The method of claim 5, wherein the castable zirconia comprises zirconia mixed with calcium, and the calcium-mixed zirconia contains calcium in an amount of 5 to 15 mol% based on 100 mol% of the calcium-mixed zirconia.

11. The method of claim 5, wherein, prior to sintering the zirconia support filled with the castable zirconia, the zirconia support filled with the castable zirconia is cured at 100 to 300°C for 1 to 5 hours, and the zirconia support filled with the castable zirconia is sintered at 700 to 1100°C for 1 to 5 hours.
